(19) United States
(12) Patent Application Publication
(10) Pub. No.: US 2024/0182335 A1
(43) Pub. Date: Jun. 6, 2024

(54) METHOD FOR TREATING FEED WATER USING A BIOSTRATUM AND FILTRATION MEDIA

(71) Applicant: DDP SPECIALTY ELECTRONIC MATERIALS US, LLC, Wilmington, DE (US)

(72) Inventors: Guillem Gilabert Oriol, Tarragona (ES); Marcus Slagt, Goes (NL); Gerard Massons, Tarragona (ES)

(21) Appl. No.: 18/552,201

(22) PCT Filed: Jan. 26, 2022
(86) PCT No.: PCT/US2022/013845

§ 371 Date: Sep. 25, 2023

(30) Foreign Application Priority Data
Mar. 25, 2021 (ES) P202130262

(51) Int. Cl. C02F 3/04; C02F 1/28; C02F 1/44; C02F 3/10

(52) U.S. Cl. CPC C02F 3/04; C02F 1/285; C02F 1/441; C02F 3/108; C02F 2303/16; C02F 2303/20

(57) ABSTRACT

A method of treating water comprising the step of passing water through a vessel comprising a bed of crosslinked resin beads having a height from 10 cm to 2 m, said bed comprising a biostratum at the top of the bed to produce treated water, wherein
(a) the area-normalized free void volume in the biostratum is 0.018 m³/m² or less;
(b) the packing density in the biostratum is 0.64 to 0.98;
(c) the ratio of the exterior surface area of the resin beads to the total free void volume in the biostratum is less than 2.0 to 50 m²/L;
(d) the velocity of the water through the biostratum is 1 to 1,500 biostratum volumes per hour;
(e) the Reynolds number of the flow through the biostratum is 0.10 to 3.0; and
(f) the vessel comprises an intermediate distributor from 5 to 195 cm below the top of the bed.

It is often desired to remove impurities from water using a purification process such as reverse osmosis or nanofiltration. One common difficulty with such purification processes is biofouling, a phenomenon in which bacteria grow on the apparatus. For example, if the purification process involves passing water through a membrane, biofouling causes the growth of a biofilm on the membrane.

WO2019212720A1 describes a method in which water is passed through a vessel containing a biostratum and then fed to a reverse osmosis membrane. It is desired to provide an improved method of pretreating impure water.

The following is a statement of the invention.

The present invention is directed to a method of treating feed water comprising the step of passing the feed water through a vessel comprising a bed of crosslinked resin beads having a height from 10 cm to 2 m, said bed comprising a biostratum at the top of the bed to produce treated water, wherein
(a) the area-normalized free void volume in the biostratum is 0.018 m³/m² or less;
(b) the packing density in the biostratum is 0.64 to 0.98;
(c) the ratio of the exterior surface area of the resin beads to the total free void volume in the biostratum is less than 2.0 to 50 m²/L;
(d) the velocity of the water through the biostratum is 1 to 1,500 biostratum volumes per hour;
(e) the Reynolds number of the flow through the biostratum is 0.10 to 3.0; and
(f) the vessel comprises an intermediate distributor located from 5 to 195 cm below the top of the bed.

The following is a brief description of the drawing.

The FIGURE shows a preferred embodiment of the present invention.

The following is a detailed description of the invention.

As used herein, the following terms have the designated definitions, unless the context clearly indicates otherwise. “Resin” as used herein is a synonym for “polymer.” Molecules that can react with each other to form the repeat units of a polymer are known herein as “monomers.” The repeat units so formed are known herein as “polymerized units” of the monomer. All percentages are by weight unless otherwise specified.

Vinyl monomers have a non-aromatic carbon-carbon double bond that is capable of participating in a free-radical polymerization process. Vinyl monomers include, for example, styrene, substituted styrenes, dienes, ethylene, ethylene derivatives, and mixtures thereof. Ethylene derivatives include, for example, unsubstituted and substituted versions of the following: vinyl acetate and acrylic monomers. “Substituted” means having at least one attached chemical group such as, for example, alkyl group, alkenyl group, vinyl group, hydroxyl group, alkoxy group, hydroxyalkyl group, carboxylic acid group, sulfonic acid group, amino group, quaternary ammonium group, and combinations thereof.

Monofunctional vinyl monomers have exactly one polymerizable carbon-carbon double bond per molecule. Multifunctional vinyl monomers have two or more polymerizable carbon-carbon double bonds per molecule.

The category “acrylic monomers” is the group of monomers selected from acrylic acid; methacrylic acid; substituted or unsubstituted alkyl esters of acrylic acid or methacrylic acid; and acrylonitrile.

As used herein, vinyl aromatic monomers are vinyl monomers that contain one or more aromatic ring. Vinyl monomers are considered to form polymers through a process of vinyl polymerization, in which the carbon-carbon double bonds react with each other to form a polymer chain.

A polymer in which at least 90% of the polymerized units (preferably at least 95%, preferably at least 99%), by weight based on the weight of the polymer, are polymerized units of one or more vinyl monomers is a vinyl polymer. A vinyl aromatic polymer is a polymer in which 50% or more of the polymerized units (preferably at least 80%, preferably at least 90%, preferably at least 95%), by weight based on the weight of the polymer, are polymerized units of one or more vinyl aromatic monomer.

A resin is considered herein to be crosslinked if the polymer includes polymerized units of multifunctional vinyl monomers, i.e., if the polymer comprises at least 1% polymerized units of multifunctional vinyl monomers. In the case of beads, the weight of the polymer is considered to be the dry weight of the bead. Resin beads may comprise typical functional groups used for ion exchange or may be unfunctionalized copolymer or “adsorbent” resins.

The degree to which a particle is spherical is characterized by the sphericity Ψ, which is defined using of the three principal orthogonal axes of the object, a (longest), b (intermediate), and c (shortest), as follows: Ψ=c/a. “Roundness” (R) is defined as the ratio of the average radius of curvature of the corners and edges of an object's silhouette to the radius of the largest circle which can be inscribed within the silhouette. Sphericity and roundness are described in more detail in H. Waddell, The Journal of Geology, vol. 41, pp. 310-331 (1933).

A collection of resin beads may be characterized by the diameters of the beads. A particle that is not spherical is considered to have a diameter equal to the diameter of a sphere having the same volume as the particle. The harmonic mean diameter (HMD) is defined by the following equation:

$$HMD = \frac{N}{{\sum }_{i = 1}^{N} ( \frac{1}{{d}_{i}} )}$$

where i is an index over the individual beads; dᵢ is the diameter of each individual particle; and N is the total number of beads.

Microorganisms are single-celled organisms, some of which exist as individual cells or as a colony of cells. Included are bacteria, protozoa, and archaea. Some fungi, and algae are microorganisms.

The biostratum is a thin layer extending downward from the top of the bed. Typically, its thickness is less than 10 cm, preferably less than 5 cm, preferably less than 2 cm. A biostratum forms when impure feed water flows through a bed of resin beads that are contained in a vessel. The microorganisms grow in a layer of the resin beads that is closest to the inlet into the vessel. The microorganisms create a biomass that contains both the cells of the microorganisms and extracellular polymeric substances (EPS) created by the microorganisms. The proportion of EPS in the biomass varies. In a typical biomass EPS may be 75% or more of the biomass by volume, or 85% or more; or 95% or more. The existence of the biostratum may be detected in a variety of ways. In many embodiments, the bed of resin beads is held in a transparent vessel, for example a vessel made of glass or transparent polyvinyl chloride. Then the region where biostratum is growing can be detected visually as a region in which opaque white material is visible between the resin beads. The invention may be practiced in any type of vessel, but transparency can aid in verifying the existence of the biostratum, and it can then be reasonably deduced that biostratum also exists in a non-transparent vessel operating under similar conditions. Also, an opaque vessel may optionally be equipped with a transparent window that allows visual observation of the biostratum. Suitable vessel materials are glass, plastic, steel, or other materials.

The existence of microorganisms in the biostratum may be verified in other ways. For example, a sample of the biostratum may be taken and examined in an optical microscope. Material characteristic of microorganisms and the resulting EPS in the interstices between the resin beads will be visible in the optical microscope. Microorganism growth may be monitored by analyzing for the presence of adenosine triphosphate; by culturing material from the suspected biostratum and counting colonies; by analyzing for total organic carbon (TOC); by analyzing for nitrogen; by analyzing for carbohydrates and/or proteins. Also, the pressure drop of the feed water passing through the vessel may be monitored. As microorganisms grow, the pressure drop becomes larger. It is contemplated that during normal operation of the method of the present invention, formation of the biostratum would be monitored by measuring the pressure drop. Other means for measuring the biomass include measure of dissolved oxygen consumption by the biomass or consumption of other nutrients than phosphates, e.g., nitrogen, carbon; and measuring bio-assimilable carbon and BOD.

Growth of microorganisms begins in between the resin beads in the region nearest the inlet to the vessel. As growth of microorganisms continues, the microorganisms are present in a layer that contains resin beads and the microorganisms; this layer is known herein as the biostratum. As growth of the microorganisms continues, the thickness of the biostratum, as measured in the net direction of water flow, also continues to grow.

Preferably, the intermediate distributor is located at least 10 cm below the top of the bed, preferably at least 15 cm; preferably no more than 100 cm, preferably no more than 75 cm, preferably no more than 50 cm. The “length” of the bed is considered to be the dimension of the bed in the direction of net flow of the water. Preferably, the intermediate distributor is located at a distance below the top of the bed of at least 3% of the bed length, preferably at least 5%, preferably at least 10%; preferably no more than 98%, preferably no more than 95%, preferably no more than 90%, preferably no more than 80, preferably no more than 70%, preferably no more than 60%. Preferably, the bed length is from 40 cm to 2 m; preferably at least 50 cm, preferably at least 60 cm, preferably at least 70 cm; preferably no more than 1.5 m, preferably no more than 1 m, preferably no more than 90 cm. In a preferred embodiment of the invention, when the bed length is from 60 cm to 1 m, then the intermediate distributor is from 5 to 55 cm from the top of the resin bed; preferably at least 8 cm, preferably at least 12 cm; preferably no more than 50 cm, preferably no more than 45 cm, preferably no more than 40 cm. The bed may comprise only one type of resin bead or more than one type.

Preferably, the intermediate distributor is a distribution system containing horizontal laterals containing wedge wire pipes or nozzles with horizontal or vertical alignment (e.g., nozzles similar to KSH ADSP or AKSP) or a star shaped distribution system (e.g., KSH series SD, SK, SS, SO). Preferably, the openings in the intermediate distributor have diameters from 0.05 to 2 mm, preferably 0.1 to 0.5 mm. Preferably, the intermediate distributor comprises openings which are distributed in a manner that produces a substantially uniform flow over the entire cross-section of the bed. Preferably, the intermediate distributor is symmetric in shape, i.e., having at least one plane of symmetry perpendicular to the cross-section. If a “star” distributor is used, preferably it comprises from three to eight pipes radiating from the center, preferably five or six. Distributors comprising parallel pipes preferably have from three to eight pipes, preferably four to six.

Preferably, the vessel contains a floating inert material in the form of amorphous particles which float at the top of the vessel. An inert material is a material which does not have functional groups typical of ion exchange resins, e.g., acidic groups, amines, quaternary ammonium groups, etc. Preferably, the inert material is a polyolefin, preferably polyethylene or polypropylene, preferably polyethylene. Preferably, the inert particles have an average sphericity from 0.7 to 1.0 and an average roundness from 0.4 to 1.0. Preferably, average sphericity is at least 0.75, preferably at least 0.80; preferably no more than 0.95, preferably no more than 0.92, preferably no more than 0.90. Preferably, average roundness is at least 0.45, preferably at least 0.50, preferably at least 0.55; preferably no more than 0.95, preferably no more than 0.90, preferably no more than 0.85, preferably no more than 0.80, preferably no more than 0.75, preferably no more than 0.70. Preferably, the average sphericity and the average roundness are not both greater than 0.95, preferably 0.90. Preferably, the inert particles have a harmonic mean diameter of at least 1 mm, preferably at least 2 mm, preferably no greater than 50 mm, preferably no greater than 25 mm, preferably no greater than 10 mm, preferably no greater than 4 mm.

Preferably, the length (perpendicular to flow) of the floating inert material in the vessel below the lowest point of the top distributor is from 100 to 500 mm, preferably from 150 to 300 mm.

Preferably, the amorphous particles have a density of at least 0.60 g/cm³, preferably at least 0.65 g/cm³, preferably at least 0.70 g/cm³, preferably at least 0.75 g/cm³, preferably at least 0.80 g/cm³, preferably at least 0.85 g/cm³. Preferably, the amorphous particles have a density no greater than 0.997 g/cm³, preferably no greater than 0.996 g/cm³.

Preferably, openings in the top distributor vary in diameter from 0.5 to 2.5 mm. The term “diameter” is used here to refer to circular openings as well as the width of openings having other shapes. In the latter case, the diameter is the largest dimension of the opening. Preferred top distributors include horizontal nozzle plates, star distributor systems and horizontal distributors having lateral pipes with wedge wires or nozzles. Preferably, the top distributor is symmetric in shape, i.e., having at least one plane of symmetry perpendicular to the cross-section. If a “star” distributor is used, preferably it comprises from three to eight pipes radiating from the center, preferably five or six.

The present invention involves the treatment of impure water, referred to herein as “feed water.” In preferred embodiments, feed water enters the vessel, passes through the biostratum, then, in the same vessel, passes through a collection of resin beads (known herein as the “bead stratum”) that has little or no microorganism or EPS content. The amount of microorganism may be characterized as the weight of microorganism per cubic centimeter. Preferably the average weight of microorganism in the bead stratum as a percentage to the average amount of microorganism in the biostratum is no more than 10%; more preferably no more than 3%; more preferably no more than 1%.

Preferred vinyl aromatic monomers are styrene, alkyl styrenes, and multifunctional vinyl aromatic monomers. Among alkyl styrenes, preferred are those in which the alkyl group has 1 to 4 carbon atoms; more preferred is ethylvinylbenzene. Among multifunctional vinyl aromatic monomers, preferred is divinylbenzene (DVB). Preferably the polymer contains polymerized units of multifunctional vinyl aromatic monomer in an amount, by weight based on the weight of polymer, of at least 1%; preferably at least 2%, preferably no more than 10%; preferably no more than 8%, preferably no more than 6%. Macroporous resin beads have pores with average diameter larger than 10 nm. Gel resin beads have porosity that is formed only by the void volumes that normally form between entangled polymer chains. Gel resin beads have average pore size of 10 nm or smaller. Preferably, the resin beads are gel resin beads.

Another intrinsic property of the resin beads is the bead density, which is the specific gravity of an individual bead. Preferably the resin beads have bead density of 1.04 to 1.6; preferably at least 1.06; preferably no more than 1.5, preferably no more than 1.4

An intrinsic property of the resin beads is the diameter. Preferably the collection of resin beads has harmonic mean diameter of 200 micrometers or larger; more preferably 300 micrometers or larger; more preferably 400 micrometers or larger. Preferably the collection of resin beads has harmonic mean diameter of 2,000 micrometers or smaller; more preferably 1,500 micrometers or smaller; more preferably 1,000 micrometers or smaller. Preferably the resin beads have number-average sphericity of 0.85 or higher; more preferably 0.90 or higher; more preferably 0.95 or higher; more preferably 0.98 or higher.

An intrinsic property of the resin beads is whether or not the resin beads contain particles of hydrated ferric oxide (HFO), which may be located inside the resin beads or on the surface of the resin beads. Preferred resin beads contain particles of HFO. The HFO particles preferably have average diameter of less than 500 nm. Preferably the amount of HFO, by weight based on the total weight of the resin beads, including the HFO, is 5% or more; more preferably 10% or more. Preferably the amount of HFO, by weight based on the weight of the resin beads (including the HFO) is 40% or less; more preferably 30% or less.

The “length” of a layer in the resin bed is considered to be the dimension of the layer in the direction of net flow of the water. In a preferred embodiment of the invention, the resin bed comprises two types of resin beads, referred to herein as Resin 1 and Resin 2. Preferably, beads of Resin 2 have a higher density than those of Resin 1.
L1=length of the Resin 1 layer
L2=length of the Resin 2 layer
   Preferably, the ratio of Resin 2 density to Resin 1 density is from 1.04:1 to 1.6:1, preferably 1.05:1 to 1.5:1, preferably 1.1:1 to 1.5:1. Preferably, the ratio of L2:L1 is from 12:1 to 1:10; preferably from 7:1 to 1:5; preferably from 4:1 to 1:3; preferably from 3:1 to 1:1.5. Preferably, L1 is from 5 to 100 cm, preferably from 10 to 70 cm, preferably from 15 to 50 cm. Preferably, L2 is from 20 to 180 cm, preferably from 25 to 120 cm, preferably from 30 to 85 cm, preferably from 35 to 70 cm. Preferably, the intermediate distributor is no lower than the bottom of the Resin 1 bed and the minimum depths from the top of the bed are as stated above.

The cross section of the vessel is the section taken perpendicular to the direction of net flow of water through the vessel. Preferably, the portion of the vessel where resin beads are present has a uniform cross section. Preferably, the cross section is circular.

Feed water passes through the biostratum and is then labeled herein as “biostratum-treated” water.

Various characteristics of the biostratum are determined as follows. Units are shown in parentheses.
Dp=diameter of a single bead=HMD of the collection of beads (m)
Vb=volume of a single bead=(4/3)(pi)(Dₚ/2)³ (cubic meter, or m³);
Sb=surface area of a single bead=4(pi)(Dₚ/2)² (square meter, or m²);
NPCM=number of beads per cubic meter=ε/Vb (m⁻³);
Av=area of the cross section of the interior volume of the vessel (m²)
As=area of the cross section of the biostratum=Av in the biostratum (m²);
Vs=volume of the biostratum=Av*L (m³);
SBV=volume of the biostratum occupied by beads=Vs*Vb*NPCM (m³);
Stot=The total surface area of the beads in the biostratum=NPCM*Vs*Sb (m²);
FVV=The free void volume in the biostratum=Vs−SBV (m³);

The biostratum may be characterized by the total free void volume. It is useful to normalize the total free void volume by dividing by the area of the cross section of the biostratum, to obtain the area-normalized free void volume (ANFVV) as follows:

ANFVV=FVV/As(m³/m²).

The area-normalized free void volume (ANFVV) is less than or equal to 0.018 m³/m²; preferably less than or equal to 0.015 m³/m². ANFVV is preferably greater than or equal to 0.001 m³/m²; more preferably greater than or equal to 0.002 m³/m².

The biostratum may be characterized by the packing density (PD), which is defined by the equation PD=1−ε, where the void fraction ε is a measured quantity and is measured at 25° C. by flowing water through the biostratum and measuring the pressure drop in the water from the inlet to the outlet of the biostratum. The packing density ε is then found by using computer modeling to solve the well-known Carman-Kozeny equation as follows:

$$\frac{dP}{L} = \frac{150 μ}{{Ψ}^{2} {D}_{p}^{2}} \frac{{( 1 - ε )}^{2}}{{ε}^{3}} v$$

where dP is the pressure drop across the biostratum (bar); L is the thickness of the biostratum (meters); μ is the viscosity of water at 25° C. (0.000897 Pa*s); v is the velocity of the water (meter/s), Dp, as defined above, is the diameter of a single bead, and Ψ is the sphericity of the bead, assumed here to be Ψ=1.

Measurement of dP/L may be made as follows. L is the length of the biostratum, which may be observed as described above and measured directly. To measure dP, one method is to measure the pressure drop (ΔPi) across the entire vessel containing resin beads, prior to any growth of microorganisms, at a specific velocity v of water passing through the vessel. Then, after growth of microorganisms has taken place, the pressure drop (ΔP1) is measured across the entire vessel while water is passing through at the same velocity v. Then dP=ΔP1−ΔPi.

The packing density (ε) is 0.64 or higher; preferably 0.70 or higher; preferably 0.74 or higher. The packing density (ε) is 0.98 or lower; preferably 0.96 or lower; preferably 0.95 or lower; preferably 0.94 or lower. The packing density will be near the lower end of the range before there is microbial growth, increase to near the upper end during operations, and then return to the lower end after a cleaning process is performed to remove biomass.

Another characteristic of the biostratum is the ratio (“RSV”) of the exterior surface area of the resin beads to the total free void volume:

RSV=Stot/FVV

RSV is 2 m²/L or higher; preferably 5 m²/L or higher; more preferably 10 m²/L or higher. RSV is 50 m²/L or lower; preferably 40 m²/L or lower; more preferably 30 m²/L or lower. RSV is first calculated using quantities having all the units listed above for the individual quantities, resulting in RSV in units of m²/m³, which is then converted to m²/L for convenience.

A characteristic of the method of the present invention is the flow rate (FR) of feed water through the biostratum. This flow rate is characterized as biostratum volumes per hour (Vs/h). The flow rate is 1 Vs/h or higher; preferably 10 Vs/h or higher; more preferably 30 Vs/h or higher; more preferably 100 Vs/h or higher; preferably 120 Vs/h or higher. The flow rate is 1,500 Vs/h or lower; preferably 1,000 Vs/H or lower; more preferably 750 Vs/h or lower.

Another characteristic of the method of the present invention is the Reynolds number (Re) of the flow through the biostratum. The FVVL is determined using the following parameters:
TVS=total void surface area=As*(1−ε) (m²);
FR=volumetric flow rate=(flow rate in Vs/h) (m³/h);
FVVL=free void velocity=FR/TVS (m/h)
ρ=density of water at 25° C.=998.2 kg/m³
μ=viscosity of water at 25° C.=0.000897 Pa*s
Dv=[(0.1547)*Dp]=[diameter of a theoretical circle that fits into the interstitial area bounded by three close-packed circles of diameter Dp in a plane] (m)
   Then the Reynolds number (Re) is determined as follows:

Re=FVVL*Dv*ρ/μ

The Reynolds number is 0.10 or higher; preferably 0.20 or higher; more preferably 0.30 or higher. The Reynolds number is 3.0 or lower; more preferably 2.0 or lower; more preferably 1.5 or lower; more preferably 1.1 or lower.

After the biostratum-treated water departs from the biostratum, it preferably immediately enters a bead stratum in the same vessel. After the water passes through the bead stratum, it is labeled herein as “treated” water.

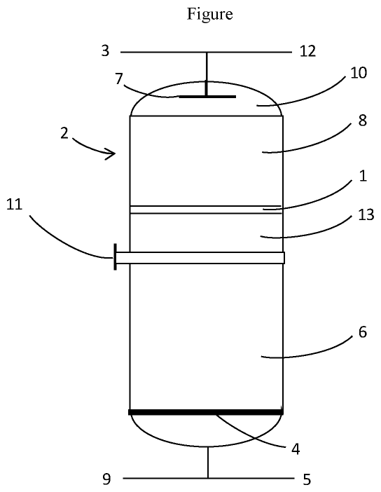

A preferred embodiment of the present invention is shown in FIG. 1. FIG. 1 shows a vertical cross section of a vessel 2 that contains resin beads. The horizontal cross section of the vessel is circular. Water enters the vessel 2 through inlet 3, then passes through the biostratum 1, becoming biostratum-treated water. The biostratum-treated water then passes through two bead strata, resin 1 layer 13 and resin 2 layer 6, becoming treated water. Resin beads are present in the bead stratum resin 1 layer 13, bead stratum resin 2 layer 6 and the biostratum 1 and the bed comprises biostratum 1 and bead strata 13 and 6. The resin beads are retained in the vessel by a barrier/top distributor 4 that allows the passage of water but holds the resin beads in place. Bead-treated water leaves the vessel 2 through an outlet 5. Also shown is a barrier/bottom distributor 7 that allows the passage of water but holds the beads in place. During a backwash of the bead stratum, water and/or air is injected through port 9. During a backwash of the biostratum, water and/or air are injected through port/intermediate distributor 11. Barrier 7 allows passage of the backwash solution as well as passage of microorganisms, EPS, and any other materials other than resin beads that had been in the biostratum. The freeboard 8 is provided to facilitate backwashing. The floating inert material 10 provides protection to barrier 7 and facilitate passage of microorganisms, EPS, and any other materials other than resin beads that had been in the biostratum to be evacuated in waste stream 12.

The present invention is further directed to a method for removing excess biomass from a biostratum with minimal disturbance of an underlying resin bed. Preferably, a cleaning process is performed frequently in the vessel described above in the statement of the invention by introducing air, water, an appropriate aqueous solution, or a combination thereof, provided that when air is used it must be followed by water or an aqueous medium, through the intermediate distributor under pressure to clean and maintain the biomass growth in the top layer, i.e., biostratum, locally, instead of the disturbing the entire bed (biostratum and bead stratum). This removes excess microorganisms and EPS from the resin beads. Preferably, the cleaning process removes 50% or more by weight of the microorganisms and 50% or more by weight of the EPS. More preferably, the cleaning process removes 90% or more by weight of the microorganisms and 90% or more by weight of the EPS. Preferably the height of the biostratum is expanded by at least 40% in the cleaning process, preferably at least 80%; preferably no more than 200%, preferably no more than 100%.

Preferably, a total backwashing process is performed at longer intervals to remove excess microorganisms and EPS from the resin beads. A backwash medium (air, water, an appropriate aqueous solution, or a combination thereof) is forced under pressure into the vessel through the outlet. The backwash medium passes through vessel in “upflow,” the direction opposite to the direction taken by the feed water. That is, the backwash medium passes through the bead stratum, then passes through the biostratum, and then exits the inlet. Preferably, the backwash process removes 50% or more by weight of the microorganisms and 50% or more by weight of the EPS. More preferably, the backwash process removes 90% or more by weight of the microorganisms and 90% or more by weight of the EPS. Preferably, as the backwash medium moves through the biostratum, the resin beads tend to sink, while the microorganisms and the EPS tend to float, and removal of the microorganisms and of the EPS proceeds more efficiently when the resin beads have higher bead density. Preferably, when air is used as a backwash medium, it is followed by water or an aqueous solution.

Treated water may be used for any purpose. It is expected that treated water will have a reduced tendency to cause biofouling in any subsequent system where it is used, e.g., in systems containing pipes, cooling towers, heat exchangers, water-purification systems, and combinations thereof. Water purification systems include, for example, ultrafiltration, microfiltration, reverse osmosis and nanofiltration, and combinations thereof. Preferably, the treated water is conveyed to an apparatus that performs a reverse osmosis (RO) process, or a nanofiltration process (NF), or a combination thereof, on the treated water. More preferably, the treated water is conveyed to an apparatus that performs a reverse osmosis (RO) process on the treated water.

The following are examples of the present invention. “Resin 2” is below “Resin 1” in the bed. In runs with an intermediate distributor air and then water were used to remove biomass. The properties of the resins are as shown below:

### Resin 1:

Particle size: 700-950 μm
Density: 1.08 g/mL
Functionality: non-functionalized
Material: Crosslinked acrylic
Sphericity: 0.99
Roundness: 0.95
Height: 30 cm (from top of bed)

### Resin 2:

Particle size: 600-700 μm
Density: 1.25 g/mL
Functionality: iron impregnated
Material: Crosslinked styrenic
Sphericity: 0.99
Roundness: 0.95
Height: 50-80 cm (from bottom of bed)

| | Distributor | | Intermediate | | |
|---|---|---|---|---|---|
| | at bottom of | | distributor | | |
| | vessel | | 30 cm below | | |
| | (comparative) | | bed surface | | Improvement |
| Resin layout | 80 cm Resin 2 | | 50 cm Resin | | |
| | | | 2 + 30 cm | | |
| | | | Resin 1 | | |
| Intermediate | No | | 30 cm below | | |
| distributor | | | bed surface | | |
| Bed expansion | 80% | | 80% | | |
| Backwash duration | 30 | | 30 | | |
| (min) | | | | | |
| Vessel diameter (cm) | 300 cm | | 300 cm | | |
| | diameter | | diameter | | |
| Backwash velocity | 24.6 | m/h | 10 | m/h | 59% reduction in |
| (m/h) | | | | | linear velocity |
| Free board (cm) | 144 | cm | 54 | cm | 63% reduction in |
| | | | | | free board |
| Vessel height (cm) | 224 | cm | 134 | cm | 40% reduction in |
| | | | | | vessel height |
| Backwash flowrate | 174 | m³/h | 71 | m³/h | 59% reduction in |
| (m³/h) | | | | | backwash volume |
| Backwash waste (m³) | 87 | m³ | 35 | m³ | 60% reduction in |
| | | | | | waste |

Cleaning was done with and without floating inert material. The material used had the following characteristics:
Particle size: 2.5-4 mm
Density: 0.95 g/mL
Functionality: non-functionalized
Material: Polyethylene
Sphericity: 0.86
Roundness: 0.61
   Height: 200 mm below the lowest point of top distribution location towards the biostratum

| | | | With inert | |
|---|---|---|---|---|
| | | | material (200 | |
| | | | mm below the | |
| | | | lowest point of | |
| | No inert material | | top distributor) | |
| Resin layout | 50 cm Resin | | 50 cm Resin | |
| | 2 + 30 cm | | 2 + 30 cm | |
| | Resin 1 | | Resin 1 | |
| Backwash duration (min) | 30 | | 30 | |
| Vessel diameter (cm) | 300 cm | | 300 cm | |
| | diameter | | diameter | |
| Backwash water velocity (m/h) | 12 | m/h | 12 | m/h |
| Backwash air velocity (m/h) | 50 | m/h | 50 | m/h |
| Vessel height (cm) | 150 | cm | 150 | cm |

The top distributor slots were inspected after performing backwash with each of the two configurations above described.
A computer analysis of images of the top distributor revealed that 72.8% of the slots contained beads trapped in the openings in the media layout configuration not using inert material. By using the bed layout configuration with the inert material and applying same backwash conditions, only 10.1% of the slots contained beads trapped in the openings.

1. A method of treating feed water comprising the step of passing the feed water through a vessel comprising a bed of crosslinked resin beads having a height from 10 cm to 2 m, said bed comprising a biostratum at the top of the bed and a bead stratum to produce treated water, wherein
(a) the area-normalized free void volume in the biostratum is 0.018 m³/m² or less;
(b) the packing density in the biostratum is 0.64 to 0.98;
(c) the ratio of the exterior surface area of the resin beads to the total free void volume in the biostratum is less than 2.0 to 50 m²/L;
(d) the velocity of the water through the biostratum is 1 to 1,500 biostratum volumes per hour;
(e) the Reynolds number of the flow through the biostratum is 0.10 to 3.0; and
(f) the vessel comprises an intermediate distributor located from 5 to 195 cm below the top of the bed.

2. The method of claim 1, wherein the bead stratum does not comprise microorganisms, and wherein the biostratum-treated water passes through the bead stratum to produce treated water.

3. The method of claim 2, further comprising a layer of inert particles having a density from 0.57 g/cm³ to 0.998 g/cm³ and a harmonic mean diameter from 2 to 4 mm.

4. The method of claim 3, wherein the inert particles are amorphous particles having average sphericity from 0.7 to 1.0 and average roundness from 0.4 to 1.0.

5. The method of claim 4, wherein the bed comprises a first type of resin bead and a second type of resin bead, wherein density of the second type of resin bead is greater than density of the first type of resin bead.

6. The method of claim 5, wherein the vessel further comprises a top distributor with openings from 0.5 to 2.5 mm in diameter.

7. The method of claim 6, wherein the method further comprises a subsequent cleaning step, which comprises forcing an aqueous medium into the vessel through the intermediate distributor, so that the water passes through the biostratum and leaves the vessel through the top distributor.

8. The method of claim 7, wherein the Reynolds number is 0.30 to 1.10.

9. The method of claim 8, wherein the method additionally comprises the step of passing the treated water through a water filtration process.
